(19) United States
(12) Patent Application Publication
(10) Pub. No.: US 2006/0199497 A1
(43) Pub. Date: Sep. 7, 2006

(54) Conditioned vestibule for a cold storage doorway

(76) Inventors: Peter R. Smith, Lewistown, MT (US); Curtis Berry, Hagerstown, MD (US); Colin D. Johnstone, Annan (GB); Paul Ashley, Scotby (GB)

Correspondence Address: Shane P. Coleman;Holland & Hart, Suite 3200, 555 17th Street, Denver, CO, 80201, US

(21) Appl. No.: 11/262,432

(22) Filed: Oct. 28, 2005

Related U.S. Application Data
(63) Continuation-in-part of application No. 10/754,678, filed on Jan. 9, 2004, now Pat. No. 6,960,129.

(30) Foreign Application Priority Data
Jan. 14, 2003 (GB) 0300729.1

(51) Int. Cl. A47J 47/00

(52) U.S. Cl. 454/173

(57) ABSTRACT

A conditioned vestibule for a cold storage doorway is provided having a trackless, bi-folding door operated by an actuator that rotates a first arm portion. The first arm portion rotates about a first end. A second arm portion is connected pivotally to a second end of the first arm portion at a hinge. The second arm portion rotates relative to the first arm portion at the hinge, in response to movement of the actuator. A door body is connected to at least one of the first and second arm portions. In one embodiment, the vestibule further includes an air curtain, including a fan that circulates air across a doorway opening across into which the first and second arm portions extend, a discharge means that discharges the air across the opening, and a return means that communicates discharged air to the fan.

### RELATED APPLICATIONS

The present invention is a continuation-in-part application and claims the benefit of a filing date of U.S. patent application Ser. No. 10/754,678, filed Jan. 9, 2004, entitled “Conditioned Vestibule for a Cold Storage Doorway,” which claims the benefit of a filing date of United Kingdom patent application no. 0300729.1, entitled “Conditioned Vestibule for a Cold Storage Doorway,” filed Jan. 14, 2003, both of which are hereby incorporated by reference.

### FIELD OF INVENTION

The present invention relates to a conditioned vestibule for a cold storage doorway. More particularly, it relates to a conditioned vestibule having a trackless, bi-folding door system.

### BACKGROUND

Frozen and refrigerated goods are normally stored in refrigerated storage rooms or “cold storage” prior to being delivered to a retailer or end user. Frequent access to these cold stores is made via doors into the stores to both deliver and remove products therefrom. Access may be for personnel only but, more often, is for loading vehicles, such as fork lift trucks, that are able to deliver and remove products in bulk from the cold store.

The use of heavily insulated solid panel cold store doors with heated perimeter seals is one solution to maintain the integrity of a cold room envelope. However, a problem with this type of door is that damage to the door caused by collisions between fork lift truck traffic and the door is virtually unavoidable, even with high speed bi-parting doors. Cold store operators have recognized this problem and have tried to overcome it by adopting alternative door types, such as fabric roll-up doors. This has meet with limited success since the doors inevitably open more slowly than equivalent-sized bi-parting horizontal sliding doors. If the door is left open, an inflow of relatively warm air is able to enter the cold store and cold air flows out of the store. This is undesirable because it allows ice crystals to form in the store and moisture droplets to form in the relatively warm side and also contributes significantly to the load on the refrigeration plant. Furthermore, ice can form on the floor around the doorway which is a safety concern. What is needed is an improved conditioned vestibule for a cold storage doorway.

### SUMMARY

There exists a need to provide a conditioned vestibule that overcomes at least some of the above-referenced deficiencies. Accordingly, at least this and other needs have been addressed by exemplary embodiments of a vestibule according to the present invention. One such embodiment is directed to a conditioned vestibule for a cold storage doorway comprising a trackless, bi-folding door. An actuator operates the door by rotating a first arm portion having first and second ends. The first arm portion rotates about the first end in response to movement of the actuator. A second arm portion, also having first and second ends, is connected pivotally at the second end to the second end of the first arm portion at a hinge. The second arm portion rotates relative to the first arm portion at the hinge, in response to movement of the actuator. A door body is connected to at least one of the first and second arm portions. In one embodiment, the vestibule further includes an air curtain, including a fan that circulates air across a doorway opening across into which the first and second arm portions extend, a discharge means that discharges the air across the doorway opening, and a return means that communicates discharged air to the fan.

In another exemplary embodiment of the present invention, a conditioned vestibule for a cold storage doorway is provided. The vestibule includes a frame including first and second side members positioned on opposing sides of a doorway opening. The vestibule further includes a fan that circulates air across the doorway opening, and air discharge means including an elongated opening running along the first side and facing the doorway opening. The air discharge means discharges air horizontally across the opening. An air return means receives the air discharged across the opening. A trackless, bi-folding door is connected to the frame at or near the air discharge means. The door folds into an open position clear of the air discharge means. The fan increases speed of the air when the door is in the open position.

In yet another exemplary embodiment of the present invention, a vestibule for a cold storage doorway is provided. The vestibule includes a bi-fold door with first and second arm portions connected at a hinge. First and second door bodies are connected, respectively, to the first and second arm portions. The vestibule further includes a means for sensing traffic on first and second sides of the door, and a means for opening the door opposite from which the traffic approaches.

### SUMMARY OF DRAWINGS

The detailed description will refer to the following drawings, wherein like numerals refer to like elements, and wherein:

FIG. 1 is a schematic diagram of a conditioned vestibule for a cold storage doorway according to one embodiment of the present invention, with the door in the closed position;

FIG. 2 is a schematic diagram of the conditioned vestibule for a cold storage doorway of FIG. 1, shown with the doors in the open position;

FIG. 3 is an elevation view of the conditioned vestibule shown in FIGS. 1 and 2 with the doors in the closed position;

FIG. 4 is a cross-section of the conditioned vestibule shown in FIG. 3 taken along the line 4-4′;

FIG. 5 is another embodiment of a frame with the door-forming members removed, illustrating horizontal air movement across the doorway opening;

FIG. 6 shows an example side member used in connection with an embodiment of the vestibule that discharges air generally horizontally across the doorway opening to counter two-way airflow;

FIG. 7 shows a front view of one embodiment of the side member with the longitudinal air discharge means shown in FIG. 6;

FIG. 8 is a cross-section of the side member taken near the top of the side member;

FIG. 9 is a cross-section of the side member taken near the middle of the side member, where the air is deflected substantially straight across the doorway opening;

FIG. 10 shows a cross-section of the side member taken near the base of the side member;

FIG. 11 shows an alternative embodiment of a vestibule spanning a doorway opening using a pair of trackless bi-fold doors;

FIG. 12 shows a top view or the vestibule shown in FIG. 11, spanning the opening;

FIGS. 13A through 13C show the vestibule moving from a closed position in FIG. 13A to an open position in FIG. 13C;

FIG. 13B shows the vestibule in an intermediate position, for example as the doors are opening or closing according to the arrows shown in FIG. 13B;

FIG. 13C shows the vestibule in an open position;

FIG. 14 shows a side view of an arm assembly of one of the doors;

FIG. 15 shows a top view of the arm portions shown in FIG. 14;

FIG. 16 shows a perspective view of one embodiment of a door;

FIG. 17 shows a perspective view of the embodiment of the arm assembly of the door shown in the closed position;

FIG. 18 shows an elevation view of an embodiment of an arm assembly of a door connected to an upper frame portion;

FIG. 19 shows a pattern view of one embodiment of a first arm portion formed from sheet metal or other suitable material, before being formed into shape;

FIG. 20 shows a pattern view of one embodiment of a second arm portion formed from sheet metal or other suitable material, before being formed into shape;

FIG. 21 shows a top view of another embodiment of the door, such as the door shown in FIG. 15;

FIG. 22 shows operation of one door in which the first and second arm portions rotate in the same direction;

FIG. 23 shows another view of the door shown in FIG. 22, used in connection with a second door;

FIG. 24 shows a schematic view of the door system shown in FIG. 23;

FIG. 25 shows a perspective view of one embodiment of a door body;

FIG. 26 shows a perspective view of one embodiment of the door body; and

FIG. 27 shows a top view of the arm assembly of a door shown in FIG. 18.

### DETAILED DESCRIPTION

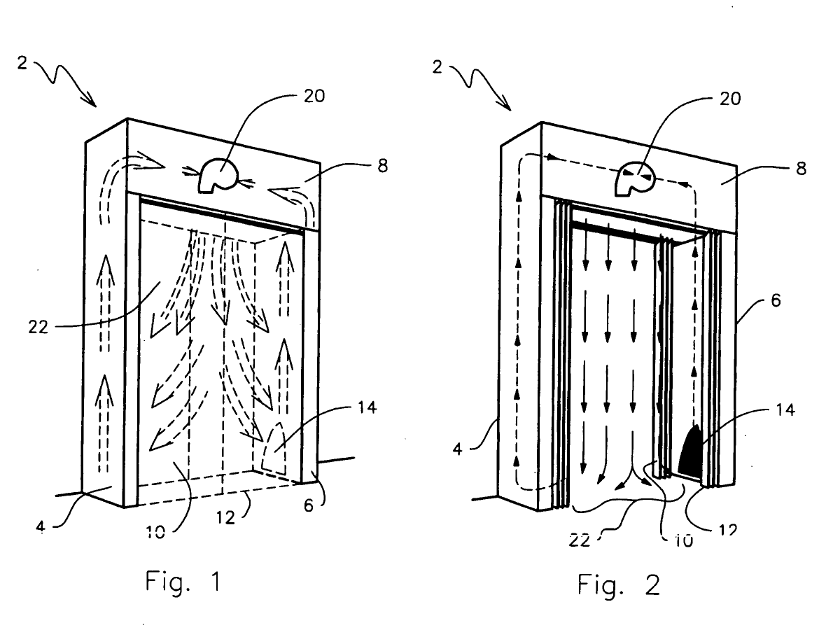

FIG. 1 is a schematic diagram of one embodiment of a conditioned vestibule 2 for a cold storage doorway in a closed position. The vestibule 2 defines a doorway opening 22 between two rooms of a building having different temperatures, such as a warm room adjacent a cold storage room. The vestibule 2 comprises a frame having parallel side members 4, 6 (sometimes referred to as “side panels”) and a horizontal top member 8 (sometimes referred to as a “top panel”) connecting the side members 4, 6. In one embodiment, the top member 8 is a hollow duct formed from sheet metal or other suitable material and houses the fan and heater assembly 20, described herein. The side members 4, 6 comprise ducts, or plenums, that control airflow across the doorway opening 22, in one embodiment.

Two sets of door-forming members 10, 12 (also referred to herein as “doors”) connect to the top member 8 and are shown in a closed position in FIG. 1. In one embodiment, the door-forming members 10, 12 are transparent polyvinyl chloride (PVC) strip curtains suspended from the top member 8. In this embodiment, one set of strip curtains is positioned toward the rear of the vestibule 2 and the other is positioned toward the front of the vestibule 2 to provide a gap of approximately 750 mm between the sets of curtains. In the example shown, the strips, or other door-forming members 10, 12, are suspended on a motorized concertina mechanism (now shown) that is able to move the door-forming members 10, 12 to an open position when activated. Alternatively, other types of door-forming members may be provided, such as single slide doors, single concertina doors, bi-parting slide doors, single or bi-parting horizontally rolling doors, single or bi-parting folding doors or hingedly mounted doors. In one embodiment, actuation means are provided to impart movement to the door-forming members.

Additionally, the vestibule 2 is provided with a variable speed fan and heater assembly 20. The assembly 20 includes a variable speed fan (now shown) and a heater (not shown). The fan and heater assembly 20 enables a controlled temperature to be maintained within the vestibule 2 by the heater when the door-forming members 10, 12 are in the closed position (shown in FIG. 1). In one embodiment, the fan and heater are positioned together in an assembly 20. In other embodiments, the fan and heater are separate.

In one embodiment, the volume of air exiting the fan increases automatically upon opening of the door-forming members 10, 12 and automatically decreases upon closing of the door-forming members 10, 12. The air volume may be controlled in various ways, such as increasing the speed of the fan motor (i.e., increasing the revolutions per minute (rpm) of the fan) or by maintaining the fan motor at a constant speed and using a mechanical damper to control the volume of airflow. Changing the volume of airflow upon opening the doors 10, 12 helps to reduce the interchange of air from one side of the vestibule 2 to the other when the doors 10, 12 are in their open position by effectively providing an air curtain across the doorway opening 22.

In one embodiment, the volume of airflow from the fan increases by 50-500%. In another embodiment, the airflow increases in a range of 50-150% upon opening of the door-forming members 10, 12. The exact speeds of the fan and the volume of airflow will depend upon the vestibule's size and site characteristics. In another embodiment, the airflow does not change upon opening or closing of the doors 10, 12.

In one embodiment, the air is directed down from the top member 8 and enters the side members 4, 6 of the frame through inlets 14 provided toward the base of the side members 4, 6 and passes back to the top member 8 where the air is re-circulated. In this example, air flow from the heater and fan is directed downwardly from the top member 8 of the frame and recirculated via inlets 14 provided towards the base of the side members 4, 6. Alternatively, the air flow may be directed horizontally between said side members 4, 6.

Upon closure of the doors 10, 12, the speed of the air discharged from the fan automatically switches back to its slower mode to circulate the reduced air flow through the vestibule 2 at a controlled temperature. This maintains a frost-free environment within the vestibule 2 to ensure that no ice or moisture accumulates on the doorway floor or on the door-forming members 10, 12. In the example of clear PVC strips used as door-forming members 10, 12, this ensures clear vision through the doorway opening 22 when the doors 10, 12 are closed because ice and moisture is not permitted to accumulate on the PVC strips.

In an example in which the fan motor speed is changed based on the door position, the detection of the opening and/or closing of the doors 10, 12 to automatically switch the speed of the fan is achieved by any suitable means, such as an inductive proximity switch to detect that the doors 10, 12 are not fully closed and, from this, to increase the speed of the fan. Alternatively, any type of limit switch may be used or a controller device which provides a signal derived from pulses produced by a rotary encoder device fitted internally to the door drive motor that controls movements of the door-forming members 10, 12. One skilled in the art will recognize that the mechanism for operation of the doors 10, 12 is not limited to a concertina mechanism. In other embodiments, for example, the doors 10, 12 may be single-slide doors, double slide doors, single concertina, bi-parting slide or hingedly mounted, or any combination or derivative of these.

The vestibule 2 may also be provided with a dehumidifier unit (not shown) that assists in the control of the moisture content within the vestibule 2. Furthermore, an insulated doorway (not shown) may also be provided within the doorway opening 22, such as a rolling type door, to provide a secured doorway. In one embodiment, the rolling type door would be lowered from the top member 8 of the frame to securely close the doorway opening 22 when frequent access through the doorway opening 22 is not required. An additional security door (not shown) may also be provided for sealing the vestibule 2, for example being of a rolling type. In one embodiment, the security door provides insulation.

FIG. 2 is a schematic diagram of the conditioned vestibule 2 for a cold storage doorway of FIG. 1, shown with the doors 10, 12 in an open position. In the example of FIG. 2, the doors 10, 12 are formed from PVC strips suspended from the top member 8 of the frame. A motor (not shown) controls movement of the strips, causing the strips to open and close the doorway. When the doors 10, 12 are in a closed position shown in FIG. 1, the fan (part of the assembly 20 in this example) operates at a first speed, to force air across the doorway opening 22 between the two door-forming members 10, 12. When the doors 10, 12 are opened to the open position shown in FIG. 2, the fan increases in speed to a second speed in order to increase the volume of airflow across the doorway opening 22. In one example, the fan increases in speed by 50-150%. When the doors 10, 12 are then closed (as shown in FIG. 1) the fan decreases in speed and, in one embodiment, returns to the first speed.

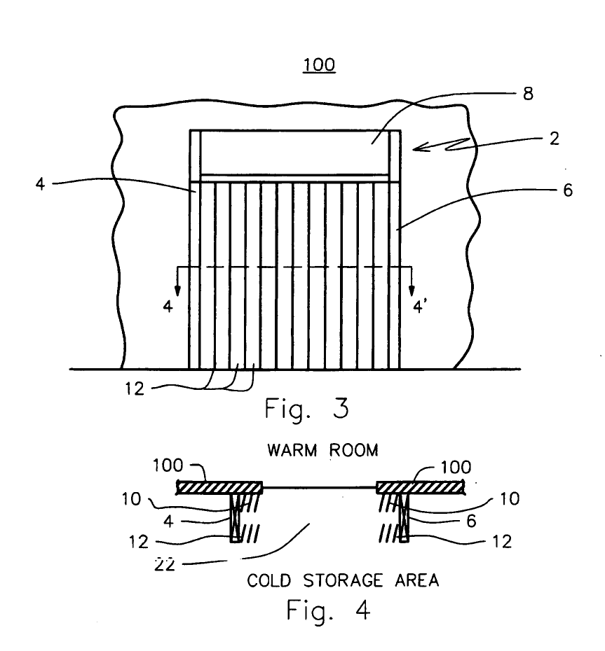

FIG. 3 is an elevation view of the conditioned vestibule 2 shown in FIGS. 1 and 2 with the doors 10, 12 in a closed position. Only one door 12 is shown in FIG. 3, because the second door (10 in FIGS. 1 and 2) is obscured from view by the first door 12. As illustrated in FIG. 3, the strips form doors 10, 12 that trap the circulated air therebetween, when the doors 10, 12 are closed. The vestibule 2 is positioned in an opening (22 in FIGS. 1 and 2) in a wall 100 that separates a cold storage room from another room.

FIG. 4 is a cross-section of the conditioned vestibule 2 shown in FIG. 3 taken along the line 4-4′, with the doors 10, 12 in the open position. In this example, the doors 10, 12 are formed from PVC strips that part in the middle of the doorway and retract into opposing side members 4, 6 of the frame when the doors 10, 12 are open. In one embodiment, the doors 10, 12 are spaced approximately 250-2500 millimeters apart when the doors 10, 12 are in the closed position. In another embodiment, the doors 10, 12 are spaced approximately 500-1000 millimeters apart from each other. In still another embodiment, the doors 10, 12 are spaced approximately 750 millimeters apart.

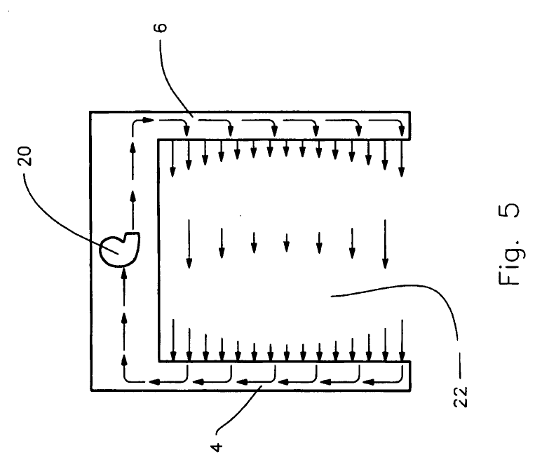

FIG. 5 is another embodiment of a frame with the door-forming members 10, 12 removed, illustrating horizontal air movement across the doorway opening 22. In the embodiment of FIG. 5, the air is forced across the doorway opening 22 horizontally. Air exits a first manifold on the right side of the example diagram of FIG. 5, which serves as an air discharge means. Air enters a second manifold on the left side of the example diagram of FIG. 5, which serves as an air inlet means. In this example, the manifolds extend along the lengths of the side-members 4, 6 of the frame. Also, the length of the arrows shown across the opening in FIG. 5 reflects the relative air momentum at different points. As shown, the air momentum is greater at the upper and lower ends of the air discharge means, in this embodiment.

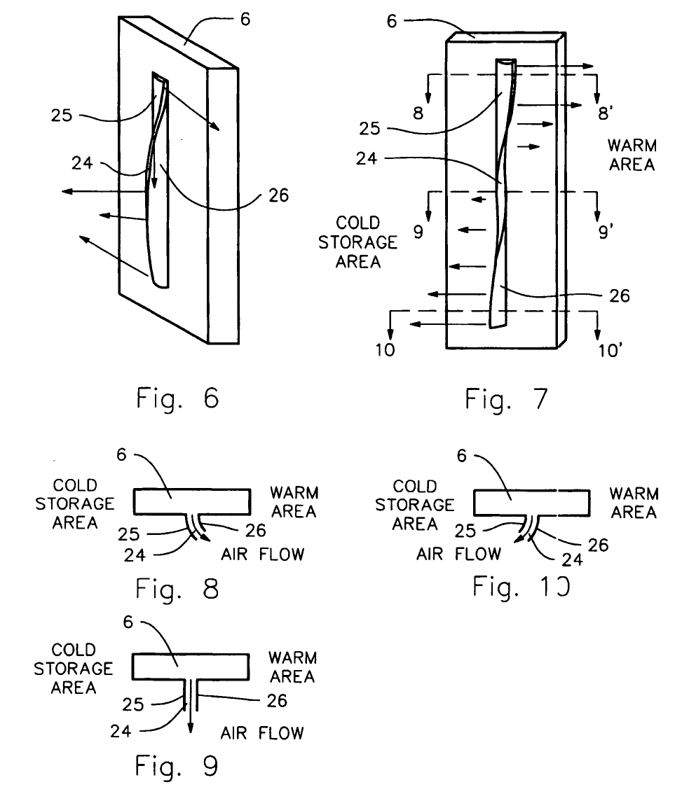

In one embodiment, the air discharge means (24 in FIG. 6) includes blades (25, 26 in FIG. 6) that deflect the air at varying angles relative to the first side member (e.g., 4) to counter two-way airflow (that is, airflow seeking to both enter and exit the cold storage room). Near the top of the air discharge means, the blades 25, 26 are positioned to deflect air toward the warmer side of the vestibule (away from the cold storage room) to counter relatively warmer air seeking to infiltrate the cold storage room. Near the bottom of the air discharge means 24, the blades 25, 26 are positioned to deflect air toward the colder side of the vestibule 2 (toward the cold storage room) to counter relatively colder air seeking to exfiltrate the cold storage room. In one embodiment, the air is circulated cross the vestibule 2 as described in U.S. Pat. No. 4,516,482 to George R. Smith, entitled “Conditioned Air Vestibule for Refrigerated Warehouse Doorway,” which is hereby incorporated by reference. In another embodiment, the air is circulated horizontally across the vestibule 2 using one or more of the horizontal air curtains described in U.S. Pat. No. 6,106,387 to George R. Smith, entitled “Conditioned and Controlled Air Vestibule for Refrigerated Warehouse,” which is hereby incorporated by reference.

In another embodiment, the blades 25, 26 deflect air in a single direction, toward or away from the cold storage room to counter one-way airflow, for example, created by exhaust fans in the building. In another embodiment, the blades 25, 26 deflect the air straight across the doorway opening 22. In still another embodiment, the blades 25, 26 are flexible insofar as they may be turned to change their orientation. In this example the flexible blades 25, 26 may be manufactured in a generally straight position and then adjusted on-site to counter opposing air flow. In another embodiment, the orientation of the flexible blades 25, 26 is controlled dynamically, after installation of the vestibule 2. For example, the orientation of the blades 25, 26 may be controlled electronically, pneumatically, hydraulically, or by any means making the adjustment automatic.

In still another embodiment, the orientation of the blades 25, 26 changes based on the door position. When the doors 10, 12 are closed, the blades 25, 26 direct air generally straight across the doorway opening 22. When the doors 10, 12 open, the blades 25, 26 automatically adjust their orientation from a first, static position to a second position that counters the air flow (e.g., toward the cold storage area at the bottom of the vestibule and away from the cold storage area near the top of the vestibule, to counter two-way airflow). When used in connection with PVC strips as the doors 10, 12, the change in blade orientation helps to maintain the strips together when the doors 10, 12 are closed because the airflow is redirected straight across the doorway opening 22 (and not toward the strips) when the doors 10, 12 are closed. In another embodiment, the gap between the blades 25, 26 is adjustable and may widen or narrow automatically based upon the position of the doors 10, 12.

FIG. 6 shows an example side member 6 used in connection with an embodiment of the vestibule 2 that discharges air generally horizontally across the doorway opening (22 in FIG. 1). The example side member 6 in FIG. 6 includes an air discharge means 24 formed by two blades 25, 26 that run generally along the length of the side member 6 from top to bottom. The arrows existing the air discharge means 24 show the flow of air out of the air discharge means 24. In this embodiment, the air discharge means 24 directs the air generally horizontally across the doorway opening (22 in FIG. 1). In this embodiment, the discharged air is returned to the fan and heater assembly (20 in FIG. 1) via an air return means (now shown) in the opposing side member (4 in FIG. 1). In one example, the air return means (not shown) is an elongated inlet hole that runs along substantially the entire length of the opposing side member (4 in FIG. 1). In one example, the air return means (not shown) is an elongated inlet hole that runs along substantially the entire length of the opposing side member (4 in FIG. 1). In one embodiment, the air discharge means varies the momentum of the discharged air along the length of the side member 6. For example, more air may be discharged faster near the top and bottom of the side member 6 than at the middle. In this example, the air return means may be shaped accordingly to accept a greater volume of returned air near the top and bottom of the opposing side member 4. In another embodiment, no blades 25, 26 are used as part of the air discharge means and instead air is discharged through an opening or nozzle without directional blades 25, 26.

FIG. 7 shows a front view of one embodiment of the side member 6 with the longitudinal air discharge means 24 shown in FIG. 6. In FIG. 7, the blades 25, 26 of the air discharge means 24 change orientation along the length of the side member 6. Near the top of the side member 6, the blades 25, 26 deflect the air toward the warm area (toward the right of this diagram) to counter relatively warmer air seeking to infiltrate the cold storage room near the top of the side member 6. Near the bottom, or base, of the side member 6, the blades 25, 26 deflect the discharged air toward the cold storage area to counter relatively cooler air seeking to exfiltrate the cold storage area near the bottom of the side member 6.

FIGS. 8, 9, and 10 show cross-sections of the side member 6 shown in FIG. 7, taken along the lines 8-8′, 9-9′, and 10-10′, respectively. FIG. 8 is a cross-section of the side member 6 taken near the top of the side member 6. The blades 25, 26 of the air discharge means 24 deflect the air toward the warm area to counter relatively warmer air seeking to infiltrate the cold storage room near the top of the side member 6. FIG. 9 is a cross-section of the side member 6 taken near the middle of the side member 6, where the air is deflected substantially straight across the doorway opening (22 in FIG. 1). FIG. 10 shows a cross-section of the side member 6 taken near the base of the side member 6. Near the base of the side member 6, the blades 25, 26 deflect the air toward the cold storage room to counter relatively cold air seeking to exfiltrate the cold storage room.

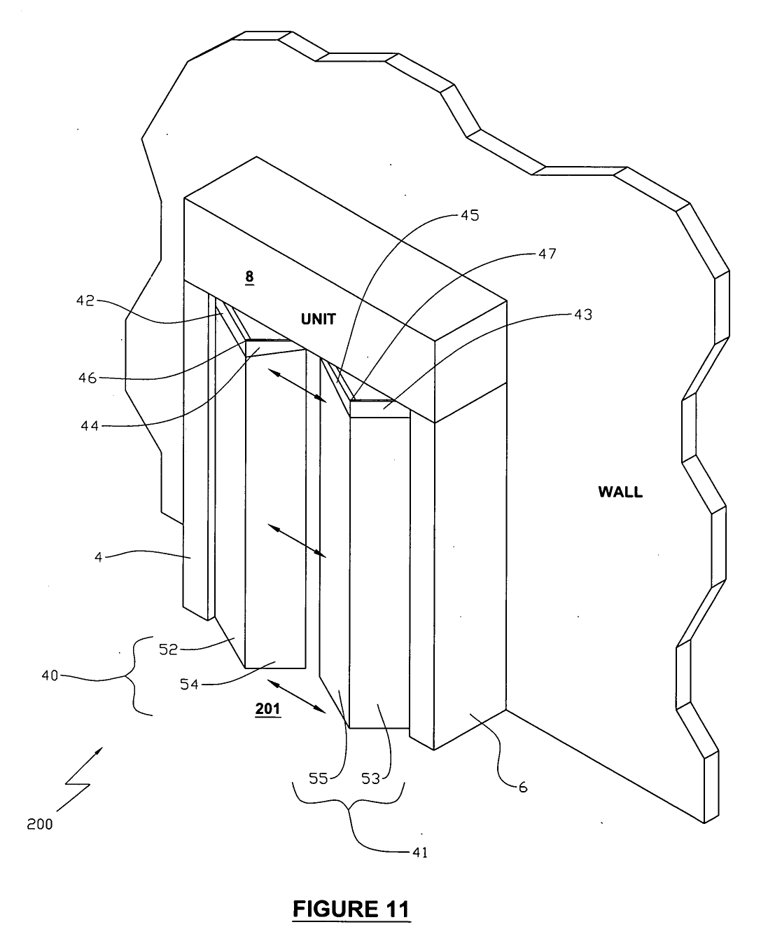

FIG. 11 shows an alternative embodiment of a vestibule 200 spanning a doorway opening 201 using a pair of trackless bi-fold doors 40, 41. In the embodiment shown, each of the doors 40, 41 includes a first rigid arm portion 42, 43 connected to a second rigid arm portion 44, 45. The first and second arm sections 42, 43, 44, 45 are connected by hinges 46, 47 respectively. Each of the doors 40, 41 in the embodiment shown in FIG. 11 includes first and second body portions 52, 54 and 53, 55, attached to and depending from the first and second arm portions 42, 43 and 44, 45, respectively. Preferably, in one embodiment the body portions 52, 53, 54, 55 are formed from a lightweight material to enable the doors 40, 41 to open and close more rapidly. In one embodiment, the body portions 52, 53, 54, 55, or some portion thereof, are formed from a transparent or translucent material to enable workers to see through the doors when they are in a closed position. In another embodiment, the body portions 52, 53, 54, 55 are formed from an opaque material, such as a lightweight rigid insulation, which is described further herein. In use, the doors open and close across the doorway opening 201. In the closed position, the doors 40, 41 are substantially flat and aligned with each other. The second body portions 54, 55 abut each other to prevent or minimize air flow through the doorway opening 201 when the doors are in the closed position. The doors 40, 41 may also be used in connection with an air curtain described above. In a preferred embodiment, the air flow across the doorway opening 201 of the air curtain increases when the doors 40, 41 are in an open position, and decreases when the doors 40, 41 return to a closed position. In the embodiment shown, the first arm portions 42, 43 of the doors 40, 41 attach to walls on either side of the doorway opening 201. The rigid members (e.g. 42, 44) attach to the walls and cantilever across the opening 201. Upper portions of the rigid members 42, 43, 44, 45 do not utilize a track as a guide across the doorway opening 201. By avoiding use of a track, the doors 40, 41 avoid maintenance associated with a track system. Also, the trackless system allows the doors 40, 41 to open and close more rapidly.

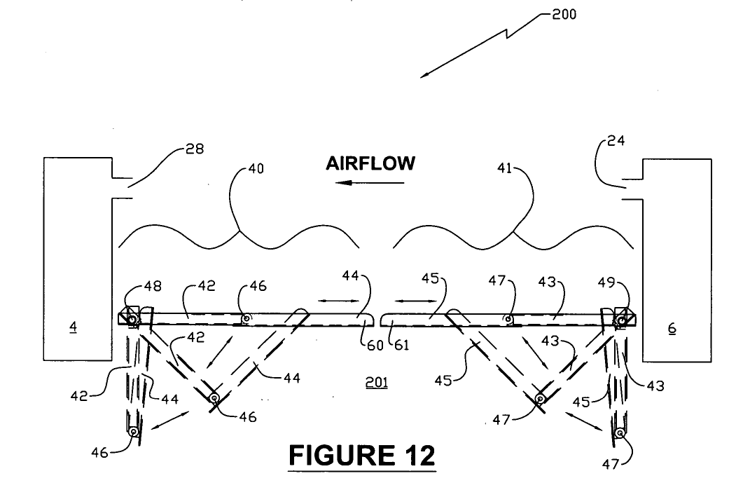

FIG. 12 shows a top view or the vestibule 200 shown in FIG. 11, spanning the opening 201. A top portion of the frame (e.g., 8 in FIG. 3) is not shown, in order to more clearly show the doors 40, 41. Doors 40, 41 are attached to side members 4, 6, respectively, of the frame. The embodiment shown in FIG. 12 utilizes an air curtain. Air is discharged through the side member 6 out the opening 24 and passes horizontally across the doorway opening 201 through the return opening 28 in side member 4, in the direction of the arrow shown as “air flow.” In the embodiment of FIG. 12, the doors 40, 41 are shown in a closed position. The doors 40, 41 may also retract to an open position, as indicated by phantom lines. Second arm portions 44, 45 of the doors 40, 41 have first ends 60, 61 that abut each other when the doors 40, 41 are in the closed position. As the doors 40, 41 move to the open position, the first arm portions 42, 43 pivot about hinges 48, 49, respectively. As the doors 40, 41 open, the second arm portions 44, 45 pivot about hinges 46, 47 relative to the first arm portions 42, 43. As the doors 40, 41 open, the first ends 60, 61 of the second arm portions 44, 45 move generally linearly and horizontally across the doorway opening 201 as shown in phantom lines. The first ends 60, 61 move independent of the top portion of the frame (e.g., 8 in FIG. 3). That is, the first ends 60, 61 move freely without requiring any track or guide.

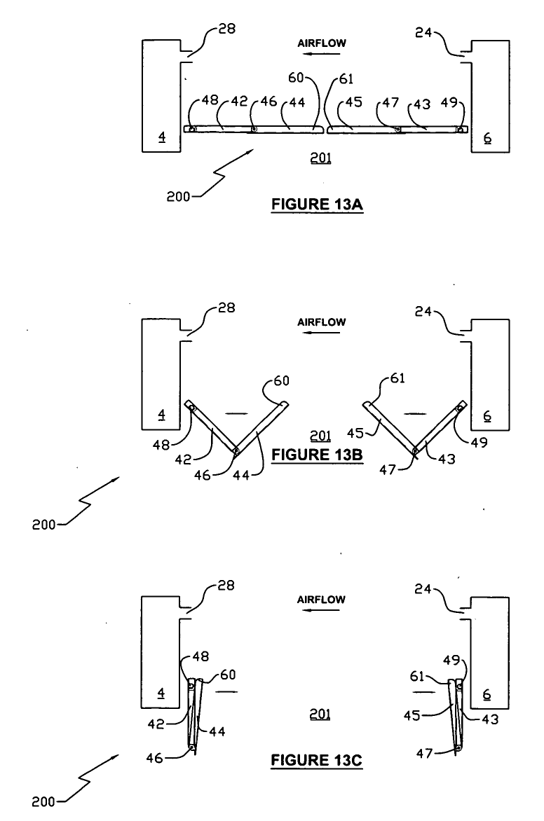

FIGS. 13A through 13C show the vestibule 200 moving from a closed position in FIG. 13A to an open position in FIG. 13C. FIG. 13A shows the vestibule 200 as substantially shown in FIG. 12. The first ends 60, 61 of the second arm portions 44, 45 are adjacent to each other in the closed position.

FIG. 13B shows the vestibule 200 in an intermediate position, for example as the doors (40, 41 in FIG. 12) are opening or closing according to the arrows shown in FIG. 13B. In the embodiment of FIGS. 13A through 13C, the vestibule 200 includes a horizontal air curtain that discharges air horizontally across the opening 201 from the discharge opening 24 to the receiving opening 28. In one embodiment, the air flow across the doorway opening 201 increases when the doors are in an open position. The first ends 60, 61 of the second arm portions 44, 45 move generally linearly across the opening 201.

FIG. 13C shows the vestibule 200 in an open position. As shown, the doors (40, 41 in FIG. 12) are each folded against frame members 4, 6 respectively. In the open position, workers and/or equipment may pass through the doorway opening 201.

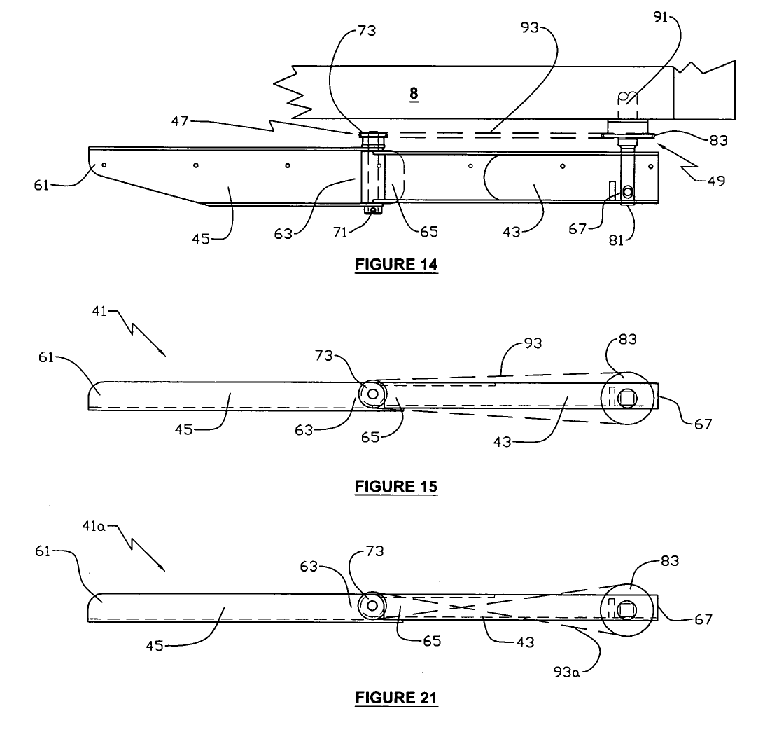

FIG. 14 shows a side view of an arm assembly of one of the doors (41 in FIG. 11). The arm assembly includes a first arm portion 43 connected to a second arm portion 45 at a hinge 47. In this embodiment, the first arm portion 43 includes first and second ends 67, 65. The first end 67 is located proximate the wall (or side member of the frame, e.g., 4, 6 in FIG. 1). The second end 65 connects to the hinge 47. A second end 63 of the second arm portion 45 connects to the hinge 47. In the embodiment of FIG. 14, the hinge 47 includes a pin 71 that is fixedly connected to the second end 63 of the second arm portion 45. The hinge 47 further includes a wheel 73, such as a pulley, gear or sprocket. The second end 65 of the first arm portion 43 pivotally connects to the pin 71 of the hinge 47.

The hinge 49 includes a pin 81 and a wheel 83, such as a pulley or sprocket. The first portion 67 of the first arm portion 43 is pivotally connected to the pin portion 81 of the hinge 49 such that the first arm portion 43 may pivot about the pin 81. Other embodiments may use different means of connecting the doors 40, 41 to the wall or frame.

In the embodiment of FIG. 14, an actuator 91 is connected to the first arm portion 43 proximate the first end 67 and causes the first arm portion 43 to rotate about the pin portion 81 of the hinge 49. In one embodiment (not shown), the actuator 91 may include an elongated drive shaft that is connected to the first end 67 of the first arm portion 43. Wheel 83 is connected to wheel 73 by linkage 93. The linkage 93 may include, for example, a chain, a rope, a belt, a cable, or other similar linkage. In one embodiment, the linkage 93 is a roller chain and the wheels 73, 83 are sprockets with teeth that fit within the roller chain. In another embodiment, the linkage 93 is a tensioned belt and the wheels 73, 83 are pulleys or sheaves. The linkage 93 is maintained about the wheels 73, 83 in such a tension that is sufficiently great enough to cause the first and second arm portions 43, 45 to pivot relative to each other about the hinge 47 in response to movement of the first arm portion 43 by the actuator 91. In one embodiment, the wheel 73 has a diameter that is approximately half the diameter of the wheel 83. In this embodiment, the second arm portion 45 moves relative to the first arm portion 43 with approximately twice the angular velocity as the first arm portion 43 moves relative to the hinge 49. As a result, the second arm portion 45 travels through approximately twice the angular distance as does the first arm portion 43 relative to the hinge 49. For example, when the first arm portion 43 moves 90 degrees at the hinge 49 (see, e.g., FIG. 13C), the second arm portion 45 rotates approximately 180 degrees in the opposition direction about hinge 47, thereby folding the arm portions 43, 45 of the door 41 into an opened position (see, e.g., FIG. 13C).

FIG. 15 shows a top view of the arm portions 43, 45, shown in FIG. 14. In the position shown in FIG. 15, the arm portions 43, 45 are aligned parallel each other in a closed-door position. The linkage 93 is tensioned and passes around wheels 73, 83. In response to rotational movement of the first arm portion 43 caused by the actuator (91 FIG. 14), the linkage 93 and wheels 73, 83 cause the second arm portion 45 to rotate in the opposite direction relative to the hinge 47 with approximately twice the rotational velocity, thereby causing the first and second arm portions 43, 45 to fold into an open-door position without the need for an overhead track or guide.

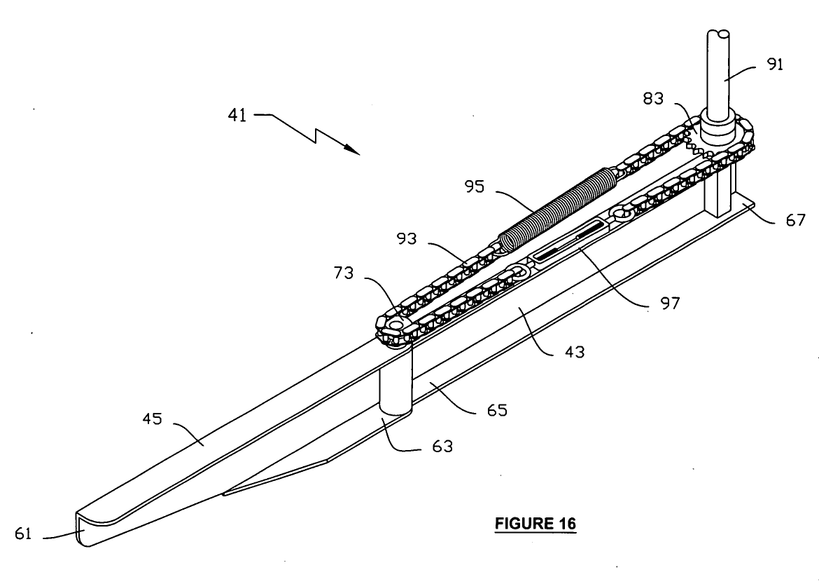

FIG. 16 shows a perspective view of one embodiment of a door 41. In the embodiment of FIG. 16, the first and second arms 43, 45 are formed from sheet metal. Although not shown in FIG. 16, this embodiment uses a chain as a part of the linkage , such as a roller chair or other similar chain adapted to engage teeth of a sprocket. The wheels 73, 83 are sprockets having teeth that engage the chain (not shown). A spring 95 connects to the chain (not shown) and provides tension. This embodiment also includes a turnbuckle adjustment 97 to adjust tension on the chain (not shown). The first wheel 83 is a sprocket having approximately twice as many teeth as the sprocket that is used for the second wheel 73.

In the embodiment of FIG. 16, the actuator 91 is a drive shaft that is connected to the first arm portion 43. The wheel 83 does not rotate with the drive shaft. In response to rotational movement of the drive shaft actuator 91, the first arm portion 43 turns, for example, until the first arm portion 43 has passed through an angle of 90 degrees. Because the second arm portion 45 is fixedly connected to the wheel 73, which is a sprocket with half as many teeth, the second arm portion 45 rotates relative to the first arm portion at a rate that is approximately twice the rate of rotation of the first arm portion 43 relative to the hinge 49 and drive shaft actuator 91. In the example above, if the first arm portion 43 passes through an angle of approximately 90 degrees, then the second arm portion 45 would pass through an angle of approximately 180 degrees in the rotational direction opposite that of the first arm portion 43, thereby folding the first and second arm portions 43, 45 into each other to open the door 41.

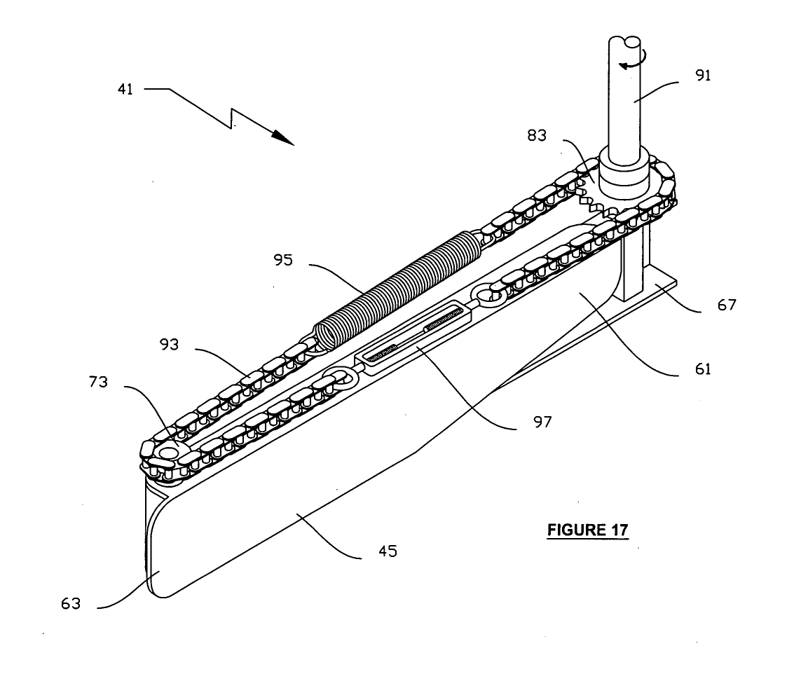

FIG. 17 shows a perspective view of the embodiment of the door 41 shown in the closed position. Arrows show clockwise rotation of the drive shaft actuator 91 and counterclockwise rotation of the second arm 45 relative to the first arm 43. The sheet metal embodiment of the first and second arm portions 43, 45 allows the first and second arm portions 43, 45 to fold into each other in an overlapping position to more compactly fold the door 41.

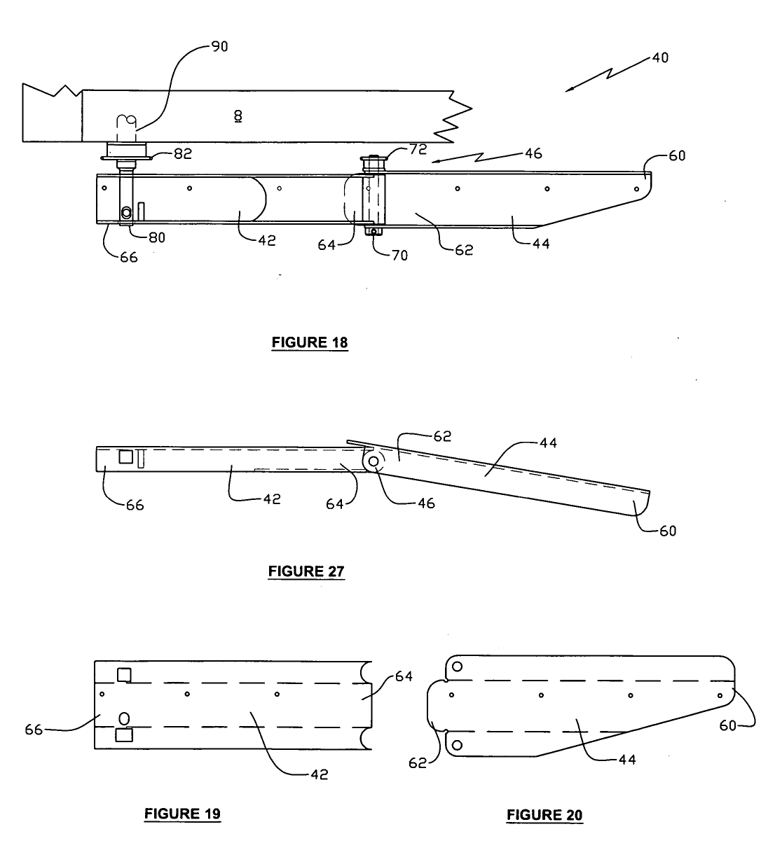

FIG. 18 shows an elevation view of an embodiment of a door 40 connected to a top frame portion 8. In the example shown, the linkage (e.g., 93 in FIGS. 14 and 15) is not shown. Wheels 72, 82 are shown and are adapted to engage linkage as described herein. First and second arm portions 42, 44 are connected at a hinge 46. An end 62 of the second arm portion 44 is fixedly connected to a pin 70 of the hinge 46. An end 64 of the first arm portion 42 connects pivotally to the pin 70 of the hinge 46. A pin 80 is connected to the actuator 90, which may be a drive shaft in this embodiment. The end 66 of the first arm portion 42 is fixedly connected to the pin 80, such that the first arm portion 42 moves in response to rotational movement of the actuator 90. The wheel 82 is permitted to move relative to the actuator 90, such that the wheel 82 does not move in response to rotational movement of the actuator and first arm portion 42.

FIG. 27 shows a top view of the arm assembly of a door 40 shown in FIG. 18. The second arm portion 44 has rotated slightly at the hinge 46, relative to the first arm portion 42.

FIG. 19 shows a pattern view of one embodiment of a first arm portion 42 formed from sheet metal or other suitable material, before being formed into shape. The first arm portion 42 has first and second ends 64, 66.

FIG. 20 shows a pattern view of one embodiment of a second arm portion 44 formed from sheet metal or other suitable material, before being formed into shape. The second arm portion 44 has first and second ends 60, 62.

FIG. 21 shoes a top view of another embodiment of the door 41 a, such as the door shown in FIG. 15. In the embodiment of FIG. 21, the first and second arm portions 43, 45 both rotate in the same direction. In this embodiment, the arm motion is accomplished using linkage 93a that crisscrosses to form a figure-8 shape around the wheels 73, 83, thereby causing the first and second arm portions 43, 45 to rotate in the same direction. In one embodiment, the wheel 73 and the wheel 83 may be of the same approximate size so that both the first and second arm portions 43, 45 rotate through approximately the same angle. In one embodiment, the door moves in either direction, as the actuator (not shown in FIG. 21) causes the first arm portion 43 to rotate either clockwise or counterclockwise. In one embodiment, sensors (not shown) are used to sense traffic approaching the vestibule, and the first arm portion 43 opens away from the direction of traffic. In another embodiment, the wheels 73, 83 have different sizes and cause the first and second arm portions 43, 45 to rotate at different velocities, through different angles, for example, to fold the second arm portion 45 into the first arm portion 43.

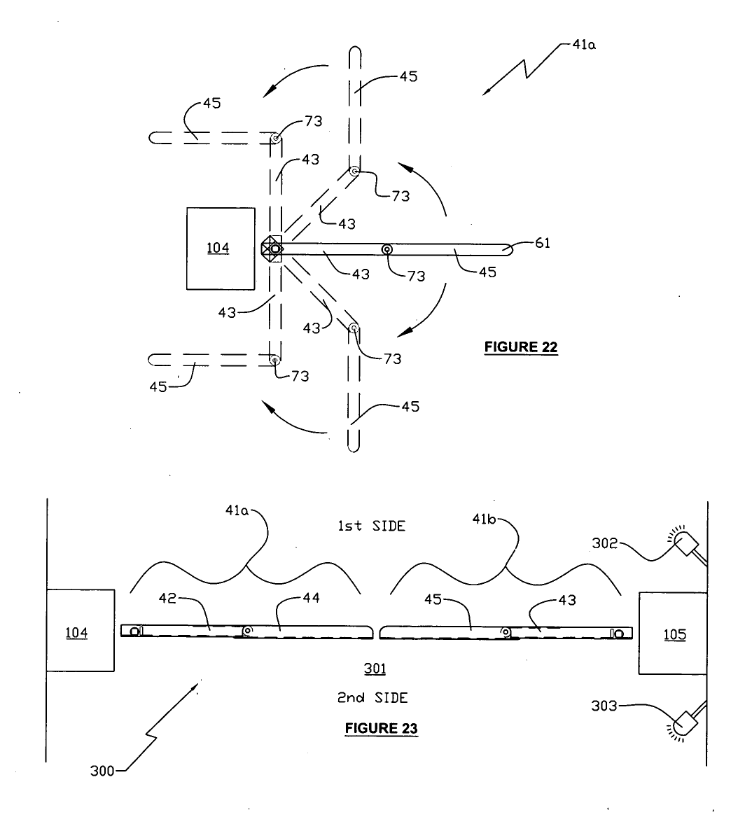

FIG. 22 shows operation of one door 41a in which the first and second arm portions 43, 45 rotate in the same direction, for example, using the configuration of the linkage 93a shown in FIG. 21. The linkage (e.g., 93a in FIG. 21) is not shown in FIG. 22, in order to more clearly show the rotation of the door 41 a from a closed position (shown in solid lines) to two separate closed positions (shown in phantom lines). In this embodiment, the door 41a is connected to a frame 104 that extends outward from a wall. The second arm portion 45 rotates through the same angle as the first arm potion 43, for example, by using wheels (e.g., 73, 83 in FIG. 21 of approximately the same size. The first and second arm portions 43, 45 rotate in the same direction, such that the second arm portion 45 is wrapped around the frame 104 in the fully opened positions. In the embodiment of FIG. 22, the door 41 a is adapted to move in either direction to open. In this embodiment, the door 41a may be configured to automatically sense approaching traffic and to open in a direction away from the traffic so that the door does not impede the traffic and so that the traffic has a lesser chance of damaging the door.

FIG. 23 shows another view of the door 41a shown in FIG. 22, used in connection with a second door 41b. Door 41b is connected to a frame 105 similar to the frame 104 that connects to door 41a. Together, the doors 41a, 41b span the vestibule 301 to form a door system 300, separating first and separate sides. Sensors 302, 303 are positioned on either side of the vestibule 301 and sense approaching traffic, such as traffic by persons or equipment. By way of example, the sensors 302, 303 may be motion sensors, or pressure sensors built into the floor, or an input device for operation by a person or a biometrics sensor that controls access through the vestibule 301. In this embodiment, the doors 41a, 41b are each adapted to move in both directions as shown in FIG. 22, for example, by using linkage described with respect to FIG. 21.

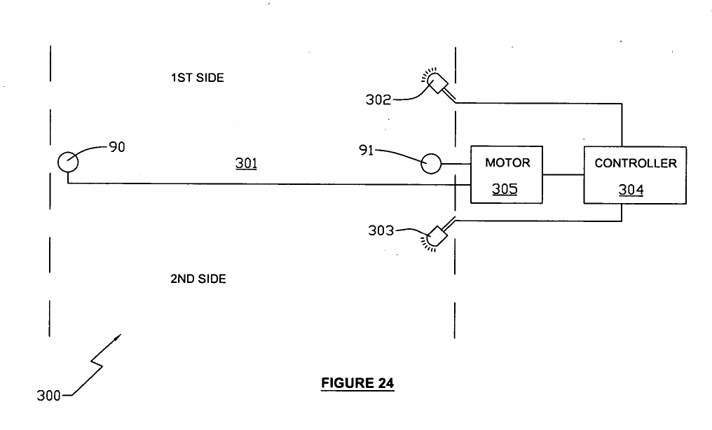

FIG. 24 shows a schematic view of the door system 300 shown in FIG. 23. Door drive shaft actuators 90, 91 are positioned on either side of the vestibule 301 and control the doors (not shown). The actuators 90, 91 are operated by a motor 305. The motor 305 operates in response to a controller 304, which receives input signals from sensors 302, 303. The sensors 302, 303 sense traffic on either the first or second sides of the vestibule 301. In response to the sensed traffic, the controller 304 causes the motor to operate the actuators 90, 91 to open the doors away from the approaching traffic. For example, if a person or piece of equipment was sensed approaching the first side of the vestibule 301, the controller 304 would cause the actuators 90, 91 to open the doors toward the second side of the vestibule 301.

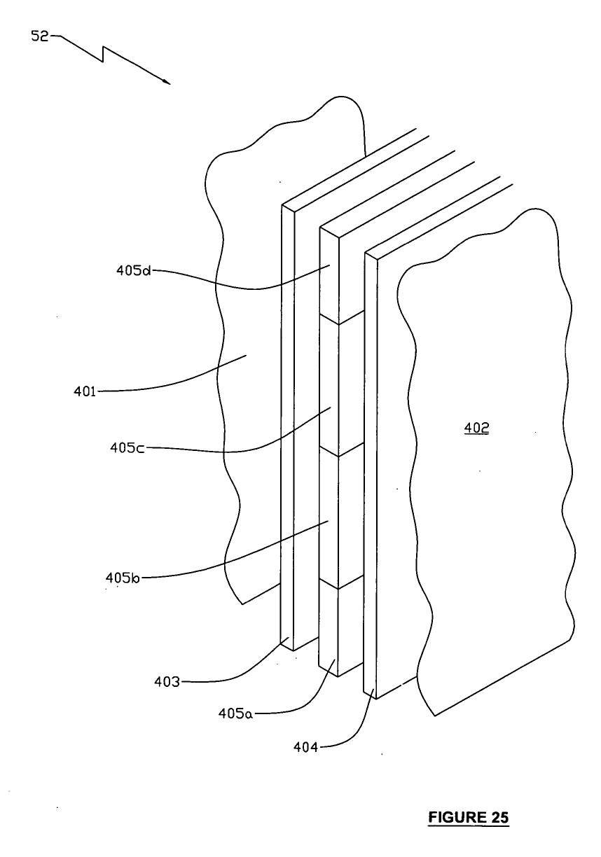

FIG. 25 shows a perspective view of one embodiment of a door body 52. In this embodiment, the door body 52 is a lightweight, insulated body formed from a plurality of rigid, high density foam insulation panels 405a-d. The insulation panels 405a-d are encapsulated by a skin having first and second sides 401, 402. In one embodiment, the skin is formed from a flexible material, such as polyvinylchloride (PVC) or urethane. First and second sides 401, 402 removably attach to each other, in one embodiment. In the example shown in FIG. 25, the door body 52 further includes first and second cushioning layers 403, 404 positioned on either side of the insulation panels 405a-d between the insulation panels 405a-d and the sides 401, 402 of the skin. The door body 52 is adapted to receive occasional impact from equipment passing through the vestibule (e.g., 301 in FIG. 23) with minimal damage to the door body 52. The cushioning layers 403, 404 absorb occasional impact without damaging the complete door system (300 in FIG. 23). In the embodiment shown, multiple door panels 405a-d are used and are interchangeable and replaceable. In the event of damage to a portion of the door body 52, one or more of the insulation panels 405a-d may be replaced without the need to replace the entire door body. In one embodiment, the skin sides 401, 402 and the cushioning material 403, 404 each attach to each other by hook and loop fasteners, such as Velcro, and the first and second sides 401, 402 of the skin attach to each other by such removable fasteners so that the insulation panels 405a-d may be accessed. In one particular embodiment, the door body 52 may be of the types described in co-pending application no. ______, filed Oct. 28, 2005, entitled “Air Heated, Flexible Door Panel,” by Curtis L. Berry and William B. Nichols, which is hereby incorporated by this reference.

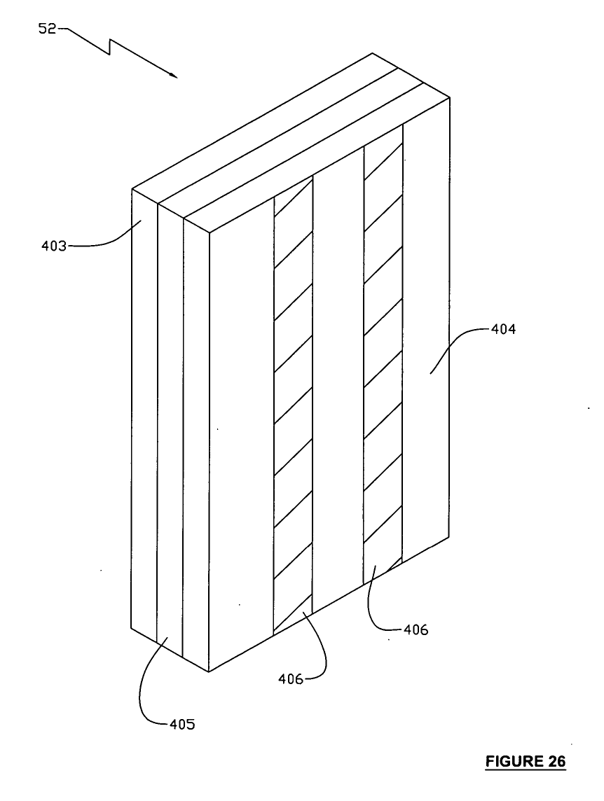

FIG. 26 shows a perspective view of one embodiment of the door body 52. The insulation layer 405 may include multiple insulation panels (e.g., 405a-d in FIG. 25). Fasteners 406, such as hook and loop strips are positioned on the cushioning material 403, 404. Similar fasteners (not shown) hold the insulation layer 405 to the cushioning material 52. In one embodiment, cushioning material 405 is not used, and the first and second sides (401, 402 in FIG. 5) of the skin are connected directly to the insulation layer 405.

Although the present invention has been described with respect to particular embodiments thereof, variations are possible. The present invention may be embodied in specific forms without departing from the essential spirit or attributes thereof. It is desired that the embodiments described herein be considered in all respects illustrative and not restrictive and that reference be made to the appended claims and their equivalents for determining the scope of the invention.

1. A conditioned vestibule for a cold storage doorway, comprising:
a trackless, bi-folding door comprising:
an actuator;
a first arm portion having first and second ends, wherein the first arm portion rotates about the first end in response to movement of the actuator;
a second arm portion having first and second ends, wherein the second end of the second arm portion is pivotally connected to the second end of the first arm portion at a hinge, and wherein the second arm portion rotates relative to the first arm portion at the hinge, in response to movement of the actuator; and
a door body connected to at least one of the first and second arm portions.

2. The vestibule of claim 1, further comprising:
a fan that circulates air across a doorway opening into which the first and second arm portions extend;
a discharge means that discharges the air across the doorway opening; and
a return means that communicates discharged air to the fan.

3. The vestibule of claim 2, wherein the discharge means discharges air horizontally across the opening.

4. The vestibule of claim 2, further comprising a frame connected to the actuator, wherein the frame comprises a top portion and first and second side portions, and wherein the discharge means comprises an elongated opening running along a length of the first side portion.

5. The vestibule of claim 2, wherein the fan changes speed depending upon a position of the first and second arm portions.

6. The vestibule of claim 2, wherein the fan increases speed when the first and second arm portions are in an open position and decreases speed when the first and second arm portions are in a closed position.

7. The vestibule of claim 2, wherein the air discharge means changes a direction in which air is discharged, depending upon a position of the first and second arm portions.

8. The vestibule of claim 1, wherein the first arm portion rotates in the opposite direction of the second arm portion.

9. The vestibule of claim 1, wherein the first arm portion rotates in the same direction as the second arm portion.

10. The vestibule of claim 1, wherein the second arm portion rotates through an angle that is greater than an angle through which the first arm portion rotates.

11. The vestibule of claim 1, wherein the second arm portion rotates through an angle that is approximately twice the angle through which the first arm portion rotates.

12. The vestibule of claim 1, wherein the first end of the second arm portion moves substantially linearly toward the first end of the first arm portion in response to rotational movement of the second arm portion.

13. The vestibule of claim 1, further comprising a frame comprising a top portion, wherein the second arm is positioned adjacent the top portion of the frame, and wherein the second end of the second arm moves independent of the top portion.

14. The vestibule of claim 1, further comprising:
a first wheel connected to the first end of the first arm portion, wherein the first wheel remains stationary in response to rotational movement of the first arm portion;
a second wheel fixedly connected to the second end of the second arm portion; and
linkage connecting the first and second wheels, wherein rotational movement of the first arm portion at the first end of the first arm portion causes rotational movement of the second arm portion at the hinge, via the linkage.

15. The vestibule of claim 14, wherein the first wheel has a diameter that is larger than the diameter of the second wheel.

16. The vestibule of claim 14, wherein the first wheel has a diameter that is twice as large as a diameter of the second wheel.

17. The vestibule of claim 14, wherein the first and second wheels comprise sprockets, and wherein the linkage comprises a roller chain that engages teeth of the sprockets.

18. The vestibule of claim 1, wherein the door body further comprises at least one detachable insulation panel.

19. The vestibule of claim 18, wherein the door body further comprises a skin having first and second sides positioned, respectively, on first and second sides of the at least one insulation panel.

20. The vestibule of claim 19, wherein the first and second sides of the skin detachably connect to each other to encapsulate and to provide access to the at least one insulation panel.

21. The vestibule of claim 18, wherein the door body further comprises a cushioning material disposed between the insulation panel and at least one of the first and second sides of the skin.

22. The system of claim 1, wherein the door body comprises a plurality of rigid, detachable insulation panels.

23. The vestibule of claim 1, further comprising a sensor that senses traffic on a first side of the opening, wherein the actuator moves the first arm portion from a closed position to an open position in response to the traffic sensed by the sensor.

24. The vestibule of claim 1, further comprising at least one sensor that senses traffic on the first and second sides of the opening, wherein the actuator moves the first arm portion in a first direction in response to detection of traffic on the first side of the opening and moves the first arm portion in a second direction in response to detection of traffic on the second side of the opening.

25. A conditioned vestibule for a cold storage doorway, comprising:
a frame comprising first and second side members positioned on opposing sides of a doorway opening;
a fan that circulates air across the opening;
air discharge means comprising an elongated opening running along the first side and facing the opening, wherein the air discharge means discharges air horizontally across the opening;
air return means that receives the air discharged across the opening; and
a trackless, bi-folding door connected to the frame proximate the air discharge means, wherein the door folds into a open position clear of the air discharge means, and wherein the fan increases speed of the air when the door is in the open position.

26. The vestibule of claim 25, wherein the door comprises:
first and second arm portions connected to each other at a hinge;
an actuator that imparts rotational movement on the first arm portion;
a first wheel connected to the first arm portion proximate the actuator;
a second first wheel connected to the hinge; and
linkage connecting the first and second wheels,
wherein movement of the first arm portion causes rotational movement of the second arm portion about the hinge.

27. The vestibule of claim 26, wherein the second wheel has a diameter that is approximately half the diameter of the first wheel, and wherein rotational movement of the first arm portion at a rate causes the second arm portion to rotate about the hinge opposite the direction of rotation of the first arm portion and at approximately twice the rate of the first arm portion.

28. A vestibule for a cold storage doorway, comprising:
a bi-fold door comprising:
first and second arm portions connected at a hinge;
first and second door bodies connected, respectively, to the first and second arm portions;
means for sensing traffic on first and second sides of the door; and
means for opening the door opposite from which the traffic approaches.

29. The vestibule of claim 28, wherein the means for opening the door comprises:
means for rotating the first arm portion about a frame of the vestibule; and
means for rotating the second arm portion about the hinge in response to movement of the means for rotating the first arm portion.

30. The vestibule of claim 28, wherein the door bodies comprise a plurality of detachable, rigid insulation panels.
